(19) United States
(12) Patent Application Publication
(10) Pub. No.: US 2023/0089540 A1
(43) Pub. Date: Mar. 23, 2023

(54) OILINESS-REDUCING AGENT, EDIBLE OIL AND FAT COMPOSITION, METHOD FOR MANUFACTURING OILINESS-REDUCING AGENT, AND METHOD FOR REDUCING OILINESS OF FOOD PRODUCT

(71) Applicant: J-OIL MILLS, INC., Tokyo (JP)

(72) Inventors: Ayako MAEDA, Tokyo (JP); Takehiko SEKIGUCHI, Tokyo (JP); Shinsuke HARUGUCHI, Tokyo (JP)

(21) Appl. No.: 17/798,447

(22) PCT Filed: Feb. 12, 2021
(86) PCT No.: PCT/JP2021/005158

§ 371 Date: Aug. 9, 2022

(30) Foreign Application Priority Data
Feb. 28, 2020 (JP) 2020-033484

(51) Int. Cl. A23D 9/04; A23L 35/00

(52) U.S. Cl. CPC A23D 9/04; A23L 35/00; A23V 2002/00

(57) ABSTRACT

There is provided an oiliness-reducing agent that is capable of reducing the oiliness perceived when a person consumes a food product.

The oiliness-reducing agent is characterized by containing, as an active ingredient, a heated oil obtained by implementing a heating treatment at 120° C. or higher on an unrefined crude oil including an expressed oil of an oil and fat raw material or an extracted oil of the oil and fat raw material, or on an oil and fat that has passed through a degumming step, a deacidification step, or a bleaching step in steps for refining the unrefined crude oil.

### TECHNICAL FIELD

The present invention relates to: an oiliness-reducing agent that is capable of, e.g., reducing the oiliness perceived when a person consumes a food product cooked in oil; an edible oil and fat composition; a method for manufacturing an oiliness-reducing agent; and a method for reducing the oiliness of a food product.

### BACKGROUND ART

Edible oils and fats are used when cooking food products such as stir-fried foods and deep-fried foods. Patent Document 1 discloses, as such an edible oil and fat, an oil and fat composition for use in stir-frying a starch-based ingredient, the oil and fat composition containing, e.g., an edible oil and fat and an emulsifier (a) having an HLB of 4.7-8.

### RELATED ART DOCUMENTS

### Patent Documents

[Patent Document 1] Japanese Laid-Open Patent Application No. 2019-150068

### DISCLOSURE OF THE INVENTION

### Problems the Invention is Intended to Solve

However, large quantities of edible oils and fats are used during cooking of food products such as stir-fried foods and deep-fried foods. Therefore, reducing oiliness when such food products are consumed is one issue to be addressed.

The present invention was contrived in view of the aforementioned issue, it being an object of the present invention to provide an oiliness-reducing agent that is capable of reducing the oiliness perceived when a person consumes a food product, an edible oil and fat composition, a method for manufacturing an oiliness-reducing agent, and a method for reducing the oiliness of a food product.

### Means for Solving the Aforementioned Problems

The oiliness-reducing agent according to the present invention is characterized by containing, as an active ingredient, a heated oil obtained by implementing a heating treatment at 120° C. or higher on an unrefined crude oil including an expressed oil of an oil and fat raw material or an extracted oil of the oil and fat raw material, or on an oil and fat that has passed through a degumming step, a deacidification step, or a bleaching step in steps for refining the unrefined crude oil.

The oiliness-reducing agent according to the present invention is, e.g., added to a food product that includes an edible oil, such as a stir-fried food or a deep-fried food, or the food product is cooked through addition of the oiliness-reducing agent, thereby making it possible to reduce the oiliness of the food product.

In the language, “a heated oil obtained by implementing a heating treatment at 120° C. or higher on an unrefined crude oil including an expressed oil of an oil and fat raw material or an extracted oil of the oil and fat raw material, or on an oil and fat that has passed through a degumming step, a deacidification step, or a bleaching step in steps for refining the unrefined crude oil,” a procedural expression is used in order to specify the substance of the “heated oil.” However, it is very difficult to analyze changes in components arising from the heating and to express the heated oil as a composition, and there are also circumstances that make it difficult to specify the physical properties of the heated oil. Therefore, this procedural description is unavoidable.

In the oiliness-reducing agent according to the present invention, a heated oil obtained by implementing a further refinement step, after the heating treatment at 120° C. or higher is implemented, on the unrefined crude oil or on the oil and fat that has passed through the degumming step, the deacidification step, or the bleaching step in the steps for refining the unrefined crude oil, may preferably be employed as the active ingredient.

In the oiliness-reducing agent according to the present invention, the oil and fat raw material is preferably corn germ.

The edible oil and fat composition according to the present invention is characterized by containing the oiliness-reducing agent.

The edible oil and fat composition according to the present invention is, e.g., added to a food product that includes an edible oil, such as a stir-fried food or a deep-fried food, or the food product is cooked through addition of the edible oil and fat composition, thereby making it possible to reduce the oiliness of the food product.

The method for manufacturing an oiliness-reducing agent according to the present invention is characterized by including a step for implementing a heating treatment at 120° C. or higher on an unrefined crude oil including an expressed oil of an oil and fat raw material or an extracted oil of the oil and fat raw material, or on an oil and fat that has passed through a degumming step, a deacidification step, or a bleaching step in steps for refining the unrefined crude oil, to obtain a heated oil.

In the method for manufacturing an oiliness-reducing agent according to the present invention, the heating treatment is preferably carried out under conditions derived according to the following expression.

35≤(T−100)×t^{0.2}≤270

In the expression, T is the heating temperature, and t is a heating time (in minutes).

In the method for manufacturing an oiliness-reducing agent according to the present invention, the heating treatment is preferably carried out on the unrefined crude oil, or on the oil and fat that has passed through the degumming step, the deacidification step, or the bleaching step in the steps for refining the unrefined crude oil, until a temperature of 140° C. or higher is reached.

The method for manufacturing an oiliness-reducing agent according to the present invention preferably includes a refining step for refining the heated oil.

In the method for manufacturing an oiliness-reducing agent according to the present invention, corn germ is preferably used as the oil and fat raw material.

The method for reducing the oiliness of a food product according to the present invention is characterized in that the oiliness-reducing agent is used when manufacturing a food product.

The method for reducing the oiliness of a food product according to the present invention is characterized in that the edible oil and fat composition is used when manufacturing a food product.

### BRIEF DESCRIPTION OF THE DRAWINGS

FIG. 1 is a graph representing the intensity of a heating odor in samples A-1 to D-14.

### MODE FOR CARRYING OUT THE INVENTION

Preferred embodiments of the present invention are described in detail below.

The oiliness-reducing agent according to the present invention contains, as an active ingredient, a heated oil obtained by implementing a heating treatment at 120° C. or higher on an unrefined crude oil including an expressed oil of an oil and fat raw material or an extracted oil of the oil and fat raw material, or on an oil and fat that has passed through a degumming step, a deacidification step, or a bleaching step in steps for refining the unrefined crude oil.

There are no particular limitations as to the oil and fat raw material. Examples thereof include soybeans, coconuts, palms, rapeseed, rice, corn germ, cottonseed, safflowers, sunflowers, olives, flaxseed, peanuts, sesame, perilla, pumpkins, almonds, and other vegetable raw materials. From the standpoint of further reducing the oiliness of a food product, the oil and fat raw material is preferably corn germ.

As the unrefined crude oil, it is permissible to use, e.g., an expressed oil obtained by pressing the oil and fat raw material, or an extracted oil obtained by performing extraction on the oil and fat raw material. It is also permissible to use, e.g., a substance obtained by mixing an expressed oil and an extracted oil.

There is no particular limitation as to the pressing. For example, the pressing can be carried out by using, inter alia, an expeller-type presser composed of a casing that is formed in a cylindrical shape and a screw that is provided so as to be capable of rotating inside the casing.

The extraction is carried out by bringing a solvent into contact with a residue remaining after the oil and fat raw material has been depressed or press-extracted, and then distilling away the solvent from a solution obtained through performing extraction on the resultant material to obtain an oil fraction. Examples of the solvent used in the extraction include hexane.

The refinement steps involve getting rid of impurities, etc., that are included in the unrefined crude oil. The refinement steps include, e.g., a degumming step, a deacidification step, a bleaching step, and a deodorization step.

The degumming step involves hydrating and removing a gum substance that principally contains a phospholipid included in the oil fraction. Specifically, in the degumming step, water vapor or water is added to the unrefined crude oil, and the resulting combination is stirred.

The gum substance included in the unrefined crude oil thereby migrates to a water layer upon being hydrated. Therefore, removing the water layer removes the gum substance from the unrefined crude oil. The degumming step may be performed by adding a degumming agent. It is permissible to use, e.g., a substance composed of an aqueous solution of an organic acid such as oxalic acid, citric acid, or phosphoric acid as the degumming agent.

The deacidification step involves removing free fatty acids included in the unrefined crude oil upon being a soap fraction. The deacidification step is performed by, e.g., treating the unrefined crude oil using an aqueous solution in which an alkaline substance such as sodium carbonate or caustic soda is dissolved in water.

The free fatty acids included in the unrefined crude oil are hydrolyzed using the aforementioned alkaline aqueous solution and form a soap. Removing the soap from the unrefined crude oil removes the free fatty acids from the unrefined crude oil.

The deacidification step is not limited to treating the unrefined crude oil using an alkaline aqueous solution, and can also be performed through, e.g., a physical refinement method. Examples of the physical refinement method include steam distillation and molecular distillation.

The bleaching step involves removing pigments included in the unrefined crude oil. The bleaching step can be performed by, e.g., adsorbing the pigments onto activated white earth, activated carbon, etc. The activated white earth, etc., to which the pigments have bonded is removed through, e.g., pressure-reduced filtration.

The deodorization step involves removing odor-bearing components included in the unrefined crude oil. The deodorization step is performed by, e.g., carrying out steam distillation under reduced pressure.

An “oil and fat that has passed through the degumming step” refers to an oil and fat obtained by subjecting the unrefined crude oil to the degumming step. An “oil and fat that has passed through the deacidification step” refers to an oil an fat obtained by subjecting the unrefined crude oil to the degumming step and the deacidification step. The oil and fat that has passed through the deacidification step may be obtained by, e.g., subjecting the unrefined crude oil to the degumming step and then to the deacidification step.

Furthermore, an “oil and fat that has passed through the bleaching step” refers to an oil an fat obtained by subjecting the unrefined crude oil to the degumming step, the deacidification step, and the bleaching step. The oil and fat that has passed through the bleaching step may be obtained by, e.g., subjecting the unrefined crude oil to each of the degumming step, the deacidification step, and the bleaching step in the stated order.

In the present invention, a heating treatment is implemented on the unrefined crude oil, or on the oil and fat that has passed through the degumming step, the deacidification step, or the bleaching step in the steps for refining the unrefined crude oil, the heating treatment being performed at 120° C. or higher, preferably 130° C. or higher and 220° C. or lower, and more preferably 130° C. or higher and 190° C. or lower. The heating treatment is carried out in a higher temperature zone than that used in, e.g., a heating treatment performed in the refinement steps for refining the unrefined crude oil, said heating treatment being performed at about 100° C. In the present description, in order to distinguish between the heating treatment performed in the refinement steps, etc., and the heating treatment performed at 120° C. or higher, the heating treatment performed at 120° C. or higher is referred to as a heating (superheating) treatment. The heated oil subjected to the heating (superheating) treatment is referred to as a superheated oil.

The oiliness-reducing agent may contain, as an active ingredient, a superheated oil obtained by: implementing the heating treatment at 120° C. or higher on the unrefined crude oil, or on the oil and fat that has passed through the degumming step, the deacidification step, or the bleaching step in the steps for refining the unrefined crude oil; and then implementing further refinement steps. Steps that were not yet implemented in the aforementioned refinement steps may be performed in these refinement steps.

The oiliness-reducing agent may be configured from only the aforementioned superheated oil, or may be configured from a substance obtained by mixing an edible oil and fat and the aforementioned superheated oil. The oiliness-reducing agent may include edible additives that correspond to the application or object of the oiliness-reducing agent.

There are no particular limitations as to the edible oil and fat. Examples thereof include: rapeseed oil, corn oil, soybean oil, palm olein, sesame oil, peanut oil, safflower oil, sunflower oil, cottonseed oil, grape seed oil, macadamia nut oil, hazelnut oil, walnut oil, pumpkin seed oil, camellia oil, tea seed oil, olive oil, rice bran oil, wheat germ oil, palm oil, palm kernel oil, coconut oil, cacao butter, and other vegetable oils and fats; beef tallow, pig lard, chicken fat, milk fat, fish oil, and other animal oils and fats; and medium-chain fatty acid triglycerides and other synthetic oils and fats.

It is also possible to use a processed oil and fat obtained by performing one or more treatments selected from among hydrogenation, fractionation, and transesterification on the aforementioned vegetable oils and fats, animal oils and fats, or synthetic oils and fats. One or more of these edible oils and fats can be used.

The oiliness-reducing agent can also be incorporated into the edible oil and fat to produce an edible oil and fat composition. The edible oil and fat composition according to the present invention preferably contains 0.03 parts by mass or more of the oiliness-reducing agent (superheated oil), and more preferably contains 0.1 part by mass or more thereof, per 100 parts by mass of the edible oil and fat.

When a food product is manufactured using such an edible oil and fat composition or oiliness-reducing agent, the oiliness of the food product can be reduced. Examples of such a food product include: tempura, French fries, hash browns, croquettes, kara-age, fried pork cutlet, fried fish, corn dogs, chicken nuggets, deep-fried tofu, doughnuts, deep-fried bread, fried rice crackers, snack foods, instant ramen, and other deep-fried foods; and yakisoba, pepper steak, twice-cooked pork, chop suey, Chinese-style fried rice, stir-fried vegetables, and other stir-fried foods. Preferred examples include deep-fried foods.

According to the oiliness-reducing agent and the edible oil and fat composition of the present invention as described above, incorporating a superheated oil serving as an active ingredient makes it possible to, e.g., reduce the oiliness of a food product such as a stir-fried food or deep-fried food that is cooked using the oiliness-reducing agent or the edible oil and fat composition, the oiliness being perceived when a person consumes the food product.

A method for manufacturing the oiliness-reducing agent described above is described next. The method for manufacturing an oiliness-reducing agent includes a step for implementing a heating treatment on an unrefined crude oil including an expressed oil of an oil and fat raw material or an extracted oil of the oil and fat raw material, or on an oil and fat that has passed through a degumming step, a deacidification step, or a bleaching step in steps for refining the unrefined crude oil, the heating treatment being performed at 120° C. or higher, preferably 130° C. or higher and 220° C. or lower, and more preferably 130° C. or higher and 190° C. or lower, to obtain a superheated oil.

In the step for obtaining the superheated oil, the heating (superheating) treatment is to be carried out under conditions derived according to expression (1).

Expression (1):

35≤(T−100)×t^{0.2}≤270 (1)

In the expression, T is the heating (superheating) temperature, and t is the treatment time (in minutes).

When the heating temperature is 140° C. or higher, the heating treatment is to be carried out at least until such a temperature is reached. In such instances, it may be a time that is exceedingly close to zero; therefore, it is permissible for t to not conform to the conditions of expression (1).

The treatment time is the time during which the oil and fat is substantially maintained at the treatment temperature after being heated and reaching the treatment temperature.

Thus, carrying out the heating (superheating) treatment makes it possible to obtain a superheated oil having the effect for reducing the oiliness of a food product.

The method for manufacturing the oiliness-reducing agent may include a refinement step for further refining the superheated oil.

### EXAMPLES

### [Test Example 1] Investigation of Conditions for Manufacturing Oiliness-Reducing Agent

(Production of Edible Oil and Fat Compositions)

Edible oil and fat compositions of samples A-1 to D-14 were produced in the configurations shown in table 1. The edible oil and fat compositions of samples A-1 to D-14 contained 0.5 mass % of any superheated oil from among samples A-1 to D-14 shown in table 1 in relation to refined rapeseed oil (made by J-Oil Mills, Inc.). Corn oil (made by Ohta Oilmill Co., Ltd.) was used as the expressed oil in table 1.

TABLE 1

| | | | | | | | | | |
|---|---|---|---|---|---|---|---|---|---|
| Expressed | → | → | → | Superheating | → | → | → | Superheated | A-1 |
| oil | | | | | | | | expressed oil | |
| ↓ | | | | | | | | ↓ | |
| Degummed | → | → | Superheating | → | → | Superheated | B-6 | Degummed | A-2 |
| oil | | | | | | degummed oil | | oil | |
| ↓ | | | | | | ↓ | | ↓ | |
| Deacidified | → | Superheating | → | Superheated | C-10 | Deacidified | B-7 | Deacidified | A-3 |
| oil | | | | deacidified oil | | oil | | oil | |
| ↓ | | | | ↓ | | ↓ | | ↓ | |
| Bleached | →Superheating | Superheated | D-13 | Bleached | C-11 | Bleached | B-8 | Bleached | A-4 |
| oil | | bleached oil | | oil | | oil | | oil | |
| ↓ | | ↓ | | ↓ | | ↓ | | ↓ | |
| Deodorized | | Deodorized | D-14 | Deodorized | C-12 | Deodorized | B-9 | Deodorized | A-5 |
| oil | | oil | | oil | | oil | | oil | |

Specifically, the heating (superheating) oil (hereafter referred to as “superheated oil”) of sample A-1 is a superheated expressed oil in which an expressed oil that is an unrefined crude oil was subjected to heating (superheating) treatment. The superheated oil of sample A-2 is a degummed oil in which the degumming step was implemented on the superheated oil of sample A-1. The superheated oil of sample A-3 is a deacidified oil in which the deacidification step was implemented on the superheated oil of sample A-2. The superheated oil of sample A-4 is a bleached oil in which the bleaching step was implemented on the superheated oil of sample A-3. The superheated oil of sample A-5 is a deodorized oil in which the deodorization step was implemented on the superheated oil of sample A-4.

The superheated oil of sample B-6 is a superheated degummed oil in which the heating (superheating) treatment was implemented on an oil and fat obtained by subjecting the unrefined crude oil to the degumming step. The superheated oil of sample B-7 is a deacidified oil in which the deacidification step was implemented on the superheated oil of sample B-6. The superheated oil of sample B-8 is a bleached oil in which the bleaching step was implemented on the superheated oil of sample B-7. The superheated oil of sample B-9 is a deodorized oil in which the deodorization step was implemented on the superheated oil of sample B-8.

The superheated oil of sample C-10 is a superheated deacidified oil in which the heating (superheating) treatment was implemented after the unrefined crude oil was subjected to the degumming step and the deacidification step. The superheated oil of sample C-11 is a bleached oil in which the bleaching step was implemented on the superheated oil of sample C-10. The superheated oil of sample C-12 is a deodorized oil in which the deodorization step was implemented on the superheated oil of sample C-11.

The superheated oil of sample D-13 is a superheated bleached oil in which the heating (superheating) treatment was implemented on an oil and fat obtained by subjecting the unrefined crude oil to the degumming step, the deacidification step, and the bleaching step. The superheated oil of sample D-14 is a deodorized oil in which the deodorization step was implemented on the superheated oil of sample D-13.

In the heating (superheating) treatment, the oil and fat was heated from normal temperature to reach 180° C., and then the temperature was maintained for 60 minutes. Each of the oil and fat compositions of samples A-1 to D-14 was produced so as to include 0.5 mass % of the aforementioned superheated oil in relation to refined rapeseed oil.

(Production of Agedama)

160 g of water was mixed into 100 g of “Kotsu no iranai tempurako” (product name, made by Nisshin Foods Inc.) to produce a batter liquid.

400 g of the edible oil and fat composition of any of samples A-1 to D-14 was heated in a single-handled pot, and the batter liquid produced as described above was fried at 170° C. for two minutes and 30 seconds to produce agedama.

(Evaluation of Flavor)

Four panel experts consumed the agedama produced as described above and evaluated the oiliness, scorched odor (scorched flavor), and grain odor of the agedama. The evaluation was conducted on the basis of the criteria shown in tables 2 and 3. Specifically, a comparative evaluation was conducted with respect to agedama cooked using an edible oil and fat composition that did not include any of the superheated oils described above and agedama cooked using individual edible oil and fat compositions that respectively included the superheated oils of samples A-1 to D-14.

The average values for the evaluations conducted by the panel experts are shown in tables 4 and 5. The “refined rapeseed oil” in table 4 was an edible oil and fat composition that did not include any of the superheated oils described above, and was obtained by implementing the degumming step, the deacidification step, the bleaching step, and the deodorization step on an unrefined crude oil but not implementing the heating (superheating) treatment.

TABLE 2
Scores in evaluation of oiliness

| Score | |
|---|---|
| 5 | Greatly reduced |
| 4 | Appreciably reduced |
| 3 | Somewhat reduced |
| 2 | Barely reduced |
| 1 | Not reduced |

TABLE 3
Scores in evaluation of grain odor and scorched odor

| Score | |
|---|---|
| 5 | Extremely weak, no perceptible difference |
| 4 | Weak |
| 3 | Moderate |
| 2 | Strong |
| 1 | Very strong |

TABLE 4

| | | Refined | | | | | | | |
|---|---|---|---|---|---|---|---|---|---|
| | | rapeseed oil | A-1 | A-2 | A-3 | A-4 | A-5 | B-6 | B-7 |
| Oiliness | Average | 1 | 3.5 | 2.9 | 2.9 | 3.6 | 3.5 | 3.3 | 3.4 |
| Scorched odor, | Average | 5 | 4.1 | 4.4 | 4.5 | 5 | 4.8 | 4.5 | 4.6 |
| scorched flavor | | | | | | | | | |
| Grain odor | Average | 5 | 5 | 5 | 5 | 5 | 5 | 5 | 5 |

TABLE 5

| | | B-8 | B-9 | C-10 | C-11 | C-12 | D-13 | D-14 |
|---|---|---|---|---|---|---|---|---|
| Oiliness | Average | 3.0 | 2.6 | 3.5 | 3.3 | 3.8 | 2.4 | 2.3 |
| Scorched | Average | 4.4 | 4.9 | 4.6 | 3.6 | 4.5 | 5.0 | 5.0 |
| odor, | | | | | | | | |
| scorched | | | | | | | | |
| flavor | | | | | | | | |
| Grain odor | Average | 5.0 | 5.0 | 5.0 | 5.0 | 5.0 | 5.0 | 5.0 |

(Evaluation of oiliness)

As shown in tables 4 and 5, it was understood that the edible oil and fat compositions including the superheated oils of samples A-1 to D-14 had an effect for reducing oiliness to a greater extent than with the refined rapeseed oil that did not include these superheated oils.

(Evaluation of scorched odor and scorched flavor)

As shown in tables 4 and 5, it was understood that a scorched odor (scorched flavor) perceived upon consumption of the agedama did not substantially change in the edible oil and fat compositions including the superheated oils of samples A-1 to D-14 relative to the refined rapeseed oil that did not include these superheated oils.

(Evaluation of grain odor)

As shown in tables 4 and 5, it was understood that a grain odor perceived upon consumption of the agedama did not substantially change in the edible oil and fat compositions including the superheated oils of samples A-1 to D-14 relative to the refined rapeseed oil that did not include these superheated oils.

### [Test Example 2] Testing of Added Amounts

(Production of Edible Oil and Fat Compositions)

Refined rapeseed oil and the superheated oil of sample A-5, which was composed of corn oil, were mixed in the ratios shown in table 6 to produce edible oil and fat compositions of samples 1 and 16 to 24.

TABLE 6

| | 1 | 16 | 17 | 18 | 19 | 20 | 21 | 22 | 23 | 24 |
|---|---|---|---|---|---|---|---|---|---|---|
| Refined | 100 | 99.99 | 99.95 | 99.9 | 99.8 | 99.5 | 99 | 98 | 95 | 90 |
| rapeseed | | | | | | | | | | |
| oil | | | | | | | | | | |
| A-5 | | 0.01 | 0.05 | 0.1 | 0.2 | 0.5 | 1 | 2 | 5 | 10 |

(Evaluation of flavor)

Agedama were produced using the edible oil and fat compositions of samples 1 and 16 to 24 in the same manner as in test example 1, and the flavor of the agedama was evaluated in terms of the oiliness, scorched odor (scorched flavor), and grain odor thereof. The average values for the evaluations conducted by the panel experts are shown in table 7. The evaluation method and the evaluation criteria are the same as in test example 1, and therefore are not described here.

TABLE 7

| | | 1 | 16 | 17 | 18 | 19 | 20 | 21 | 22 | 23 | 24 |
|---|---|---|---|---|---|---|---|---|---|---|---|
| Oiliness | Average | 1 | 1 | 1.6 | 2.3 | 2.8 | 3.5 | 3.0 | 3.1 | 3 | 3.1 |
| Scorched odor, | Average | 5 | 5 | 5 | 4.8 | 4.8 | 4.8 | 4.8 | 4.6 | 4.6 | 4.6 |
| scorched flavor | | | | | | | | | | | |
| Grain odor | Average | 5 | 5 | 5 | 5 | 5 | 5 | — | — | — | — |

(Evaluation of Oiliness)

As shown in table 7, the effect for reducing oiliness to a greater extent than with sample 1 was not obtained in samples 16 and 17. However, the effect for reducing oiliness was obtained in samples 18 to 24.

(Evaluation of Scorched Odor and Scorched Flavor)

As shown in table 7, the evaluation scores pertaining to scorched odor (scorched flavor) for samples 18 to 20 were slightly lower than that for sample 1. The evaluation scores for samples 21 to 24 were slightly lower than that for sample 1 and higher than those for samples 18 to 20.

(Evaluation of Grain Odor)

As shown in table 7, the evaluation scores pertaining to grain odor for samples 16 to 20 were the same as that for sample 1, and did not differ from evaluation 1.

### [Test Example 3] Evaluation of Heating Temperature and Heating Time

A comparative evaluation of changes in flavor imparted by the heating (superheating) treatment temperature and treatment time was conducted using the superheated oil of sample A-1.

(Production of Edible Oil and Fat Compositions)

A plurality of superheated oils were produced by changing the treatment temperature and treatment time in the heating (superheating) treatment carried out when producing sample A-1, which was composed of corn oil.

Specifically, the treatment was carried out with the treatment temperature being set to 120° C., 140° C., 160° C., or 180° C. In addition, the treatment was carried out with the treatment time being set to 0 minutes, 5 minutes, 10 minutes, 30 minutes, 60 minutes, 90 minutes, or 120 minutes.

The treatment time is the time during which the oil and fat is substantially maintained at the treatment temperature after the temperature of the oil and fat reaches the treatment temperature. For example, when the treatment time is zero minutes, the oil and fat is heated from normal temperature, and then the treatment ends once the oil and fat has reached the treatment temperature.

(Evaluation of Flavor)

Edible oil and fat compositions were produced so as to include 0.5% of the superheated oil of sample A-1, which was made of corn oil that had been subjected to the heating (superheating) treatment described above, in relation to refined rapeseed oil.

Agedama were produced using edible oil and fat compositions produced in the same manner as in test example 1, and the flavor of the agedama was evaluated in terms of the oiliness, scorched odor (scorched flavor), and grain odor thereof. The average values for the evaluations conducted by the panel experts are shown in tables 8, 10, and 11. The evaluation method and the evaluation criteria are the same as in test example 1, and therefore are not described here.

(Evaluation of Oiliness)

TABLE 8

| Heating | Heating time | | | | | | |
|---|---|---|---|---|---|---|---|
| temper- | 0 | 5 | 10 | 30 | 60 | 90 | 120 |
| ature | min | min | min | min | min | min | min |
| 120° C. | 1 | 1 | 1 | 3 | 3 | 3 | 3 |
| 140° C. | 4 | 4 | 4 | 4 | 4 | 4 | 5 |
| 160° C. | 4 | 4 | 4 | 5 | 5 | 5 | 5 |
| 180° C. | 4 | 4 | 4 | 5 | 5 | 5 | 4 |
| 200° C. | 4 | 4 | 4 | 4 | 3 | 3 | 3 |

As shown in table 8, at a heating (superheating) treatment temperature of 120° C., the effect for reducing oiliness was not observed in the edible oil and fat compositions including the superheated oil for which the treatment time was 0-10 minutes. However, the effect for reducing oiliness was observed in the edible oil and fat compositions including the superheated oil for which the treatment time was 30-120 minutes.

At a heating (superheating) treatment temperature of 140° C. or higher, the effect for reducing oiliness was observed in the edible oil and fat compositions including the superheated oil irrespective of the treatment time. Specifically, at a treatment temperature of 140° C. or higher, the effect for reducing oiliness was observed even at a treatment time of zero minutes.

In addition, there was observed a trend in which the effect for reducing oiliness increased in association with increases in the treatment time, except in cases where the heating (superheating) treatment temperature was 200° C.

Values quantified using the following expression, with respect to the relationship between the heating temperatures and heating times shown in table 8, are shown in table 9.

(T−100)×t^{0.2}

In the expression, T is the heating temperature, and t is the treatment time (in minutes).

TABLE 9

| Heating | Heating time | | | | | | |
|---|---|---|---|---|---|---|---|
| temper- | 0 | 5 | 10 | 30 | 60 | 90 | 120 |
| ature | min | min | min | min | min | min | min |
| 120° C. | 0 | 28 | 32 | 39 | 45 | 49 | 52 |
| 140° C. | 0 | 55 | 63 | 79 | 91 | 98 | 104 |
| 160° C. | 0 | 83 | 95 | 118 | 136 | 148 | 156 |
| 180° C. | 0 | 110 | 127 | 158 | 181 | 197 | 208 |
| 200° C. | 0 | 138 | 158 | 197 | 227 | 246 | 261 |

When the relationship between the numeric values shown in table 9 and the oiliness is considered on the basis of the average evaluation values shown in table 8, it can be said that the oiliness is reduced when the numeric value in table 9 is 35 or greater and 270 or less. Therefore, it is desirable for the following expression to be satisfied in the heating treatment.

35≤(i−100)×t^{0.2}≤270

In the expression, T is the heating temperature, and t is the treatment time (in minutes).

(Evaluation of grain odor)

TABLE 10

| Heating | Heating time | | | | | | |
|---|---|---|---|---|---|---|---|
| temper- | 0 | 5 | 10 | 30 | 60 | 90 | 120 |
| ature | min | min | min | min | min | min | min |
| 120° C. | 3 | 3 | 4 | 4 | 4 | 4 | 4 |
| 140° C. | 3 | 3 | 4 | 4 | 4 | 4 | 4 |
| 160° C. | 4 | 4 | 4 | 5 | 5 | 5 | 5 |
| 180° C. | 4 | 4 | 5 | 5 | 5 | 5 | 5 |
| 200° C. | 4 | 5 | 5 | 5 | 5 | 5 | 5 |

As shown in table 10, when the heating (superheating) treatment temperature was 120° C. or 140° C., the evaluation score for a treatment time of 0 minutes or 5 minutes was 3. Moreover, the evaluation score for a treatment time of ten minutes or greater was 4.

When the heating (superheating) treatment temperature was 160° C., the evaluation score for a treatment time of zero to ten minutes was 4. Moreover, the evaluation score for a treatment time of 30 minutes or greater was 5.

When the heating (superheating) treatment temperature was 180° C., the evaluation score for a treatment time of zero to five minutes was 4. Moreover, the evaluation score for a treatment time of ten minutes or greater was 5.

When the heating (superheating) treatment temperature was 200° C., the evaluation score for a treatment time of zero minutes was 4. Moreover, the evaluation score for a treatment time of five minutes or greater was 5.

Thus, a trend appeared in which the grain odor became less readily perceptible as the heating (superheating) treatment temperature increased. In addition, the grain odor became less readily perceptible as the heating (superheating) treatment time increased.

(Evaluation of Scorched Odor)

TABLE 11

| Heating | Heating time | | | | | | |
|---|---|---|---|---|---|---|---|
| temper- | 0 | 5 | 10 | 30 | 60 | 90 | 120 |
| ature | min | min | min | min | min | min | min |
| 120° C. | 5 | 5 | 5 | 4 | 4 | 4 | 4 |
| 140° C. | 5 | 5 | 5 | 4 | 4 | 4 | 4 |
| 160° C. | 5 | 5 | 5 | 4 | 4 | 4 | 4 |
| 180° C. | 5 | 5 | 4 | 4 | 3 | 3 | 3 |
| 200° C. | 4 | 4 | 4 | 3 | 3 | 3 | 3 |

As shown in table 11, when the heating (superheating) treatment temperature was 120-160° C., the evaluation score for a treatment time of 0-10 minutes was 5. Moreover, the evaluation score for a treatment time of 30 minutes or greater was 4.

When the heating (superheating) treatment temperature was 180° C., the evaluation score for a treatment time of zero minutes or five minutes was 5. The evaluation score for a treatment time of ten minutes or 30 minutes was 4. The evaluation score for a treatment time of 60 minutes greater was 3.

When the heating (superheating) treatment temperature was 200° C., the evaluation score for a treatment time of 0-10 minutes was 4. The evaluation score for a treatment time of 30 minutes greater was 3.

Thus, no conspicuous scorched odor was perceptible when cooking was performed using an edible oil and fat composition including a superheated oil, irrespective of the heating (superheating) treatment temperature and time. In addition, although a trend appeared in which the scorched odor marginally increased in association with increases in the heating (superheating) treatment time, this trend was not an issue of any practical note.

### [Test Example 4] Evaluation of Type of Superheated Oil

(Production of oil and fat compositions)

The superheated oil of sample A-1 was produced using expressed corn oil, extracted soybean oil, or expressed rapeseed oil. Edible oil and fat compositions were produced so as to include 0.5 mass % of the superheated oil, which was composed of the expressed corn oil, the extracted soybean oil, or the expressed rapeseed oil, in relation to refined rapeseed oil. The heating (superheating) treatment for the aforementioned superheated oil was performed at 180° C. for 60 minutes.

(Evaluation of Flavor)

Agedama were produced using the edible oil and fat compositions produced in the same manner as in test example 1, and the oiliness of the agedama was evaluated. The average values for the evaluations conducted by the panel experts are shown in table 12.

TABLE 12

| | Expressed | Extracted | Expressed |
|---|---|---|---|
| Evaluation of oiliness | corn oil | soybean oil | rapeseed oil |
| Extracted oil or expressed | 1 | 2 | 1 |
| oil | | | |
| Superheated extracted oil | 5 | 3 | 3 |
| or superheated expressed | | | |
| oil | | | |

(Evaluation of Oiliness)

As shown in table 12, it was understood that the edible oil and fat compositions including the superheated oil, which was composed of the expressed corn oil, the extracted soybean oil, or the expressed rapeseed oil, exhibited the effect for reducing oiliness to a greater extent than an edible oil and fat composition that did not include the superheated oil. It was also understood that the effect for reducing oiliness was greater in the edible oil and fat composition including the superheated oil composed of corn oil than in the edible oil and fat composition including the superheated oil composed of soybean oil or the edible oil and fat composition including the superheated oil composed of rapeseed oil.

### [Test Example 5] Effect of Heating Odor

(Production of Oil and Fat Compositions)

Edible oil and fat compositions were produced so as to include 0.5 mass % of any superheated oil among the superheated oils of samples A-1 to D-14, which were composed of corn oil, in relation to refined rapeseed oil. The heating (superheating) treatment for the superheated oils of samples A-1 to D-14 was performed at 180° C. for 60 minutes.

(Method for Evaluating Heating Odor)

The heating odor of the aforementioned edible oil and fat compositions was evaluated. The evaluation of the heating odor was conducted by introducing 600 g of each of the edible oil and fat compositions into a magnetic dish, heating the edible oil and fat compositions at 180° C. for 30 hours, and then having fifteen panel experts sniff the individual edible oil and fat compositions (which had been heated for 30 hours). The average values assigned by the fifteen panel experts are shown in table 13. The heating odor is derived from refined rapeseed oil. The evaluations conducted by the panel experts were based on the criteria shown in table 14.

TABLE 13

| Refined rapeseed oil | A-1 | A-2 | A-3 | A-4 | A-5 | B-6 | B-7 | B-8 | B-9 | C-10 | C-11 | C-12 | D-13 | D-14 |
|---|---|---|---|---|---|---|---|---|---|---|---|---|---|---|
| 2.3 | 2.4 | 2.1 | 1.9 | 1.8 | 2.1 | 3.2 | 3.0 | 1.8 | 2.0 | 1.9 | 1.7 | 2.3 | 1.6 | 2.2 |

TABLE 14

| Score | |
|---|---|
| 5 | Intensely strong odor |
| 4 | Strong odor |
| 3 | Moderately perceptible |
| 2 | Weak odor |
| 1 | Barely perceptible odor |
| 0 | No odor |

(Evaluation of Heating Odor)

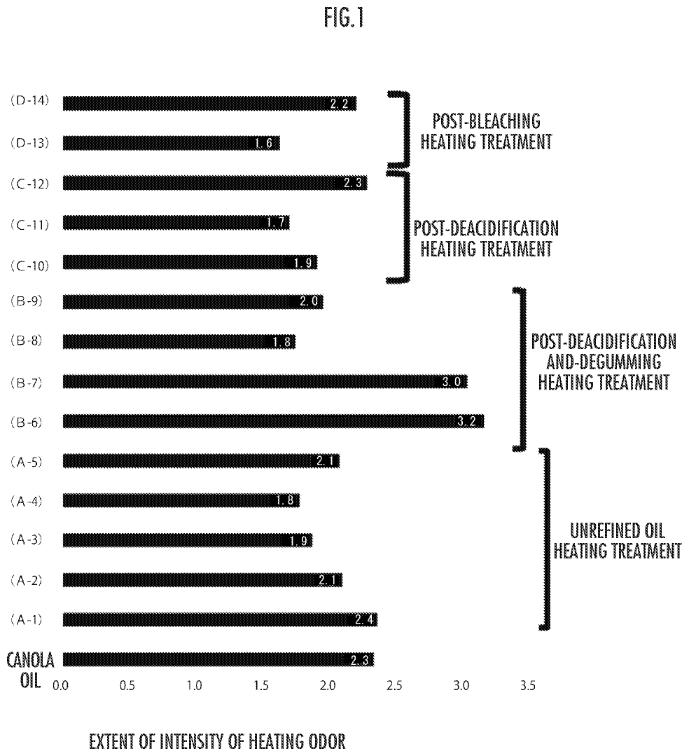

As shown in table 13 and FIG. 1, it was understood that the heating odor of the edible oil and fat compositions including the superheated oil was reduced to a greater extent than that of an edible oil and fat that did not include the superheated oil, except in the case of the edible oil and fat compositions including samples B-6 and B-7.

### [Test Example 6] Evaluation of Other Food Products

(Dressing)

(Production of Edible Oil and Fat Compositions)

Edible oil and fat compositions were produced using: the superheated oil of sample C-12, which was composed of corn oil; the superheated oil of sample A-5, which was composed of corn oil; and a refined soybean oil (made by J-Oil Mills, Inc.). The heating (superheating) treatment for the superheated oils was performed at 180° C. for 60 minutes.

Specifically, there were produced: the refined soybean oil that did not include a superheated oil; edible oil and fat compositions obtained by mixing the refined soybean oil and either the superheated oil of sample A-5, which was composed of corn oil, or the superheated oil of sample C-12, which was composed of corn oil, in a ratio of 50:50; and edible oil and fat compositions configured from only the superheated oil of sample A-5, which was composed of corn oil, or the superheated oil of sample C-12, which was composed of corn oil.

(Production of Dressings)

Dressings were produced by mixing 18 g of the edible oil and fat compositions, 1 g of vinegar (product name: Grain vinegar, made by Mizkan Co., Ltd.), and 0.2 g of salt (product name: Table salt, made by The Salt Industry Center of Japan).

(Evaluation of Dressing Flavor)

White-meat fish for frying was cooked in oil, the aforementioned dressings produced as described above were applied, and evaluations were conducted as to oiliness and an effect for masking a fish odor. Average values for the evaluations conducted by the panel experts are shown in table 15. The evaluation methods and the criteria for evaluating the oiliness are the same as in test example 1, and therefore are not described here. The criteria pertaining to the effect for masking the fish odor are shown in table 16.

Refined soybean oil was used in cooking the white-meat fish for frying in oil. The fish odor is derived from the raw-material fish of the white-meat fish for frying.

TABLE 15

| | | Soybean oil | C-12 | | A-5 | |
|---|---|---|---|---|---|---|
| Dressing | | 100% | 100% | 50% | 100% | 50% |
| Oiliness | Average | 2 | 3.5 | 3 | 3.5 | 3 |
| Masking | Average | 2 | 4.25 | 3.5 | 4.25 | 3.5 |

TABLE 16
Scores in evaluation of fish odor

| Score | |
|---|---|
| 5 | Extremely weak, no perceptible difference |
| 4 | Weak |
| 3 | Moderate |
| 2 | Strongly perceptible |
| 1 | Extremely strongly perceptible |

(Evaluation of Oiliness)

As shown in table 15, it was understood that the oiliness of the edible oil and fat composition configured from the superheated oil and of the edible oil and fat composition including the superheated oil was reduced to a greater extent than that of the edible oil and fat composition that did not include the superheated oil.

(Evaluation of Masking Effect)

As shown in table 15, it was understood that the fish odor of the edible oil and fat composition configured from the superheated oil and of the edible oil and fat composition including the superheated oil was reduced to a greater extent than that of the edible oil and fat composition that did not include the superheated oil.

### [Test Example 7] Evaluation of Other Food Products (Fried Rice)

(Production of Edible Oil and Fat Compositions)

Edible oil and fat compositions were produced using: the superheated oil of sample C-12, which was composed of corn oil; the superheated oil of sample A-5, which was composed of corn oil; the refined soybean oil; and a refined corn oil (made by J-Oil Mills, Inc.). The heating (superheating) treatment for the superheated oils was performed at 180° C. for 60 minutes.

(Production of Fried Rice)

The surface of a frying pan was heated to 220° C., and 15 g of the edible oil and fat compositions was introduced into the frying pan. 30 seconds after the edible oil and fat compositions were introduced, rice that had been heated in a stipulated heating time using a microwave oven was introduced into the frying pan, and the rice was stir-fried while being combined for two minutes. 1.5 g of salt was then introduced into the frying pan, and the contents of the frying pan were stir-fried while being combined for one minute to obtain fried rice.

(Evaluation of Fried Rice Flavor)

The oiliness of the fried rice produced as described above was evaluated. The average values for the evaluations conducted by the panel experts are shown in table 17. The evaluation method and the criteria for evaluating the oiliness are the same as in test example 6, and therefore are not described here.

TABLE 17

| | | Refined | | | Refined |
|---|---|---|---|---|---|
| Fried rice | | soybean oil | C-12 | A-5 | corn oil |
| Oiliness | Average | 2.25 | 4.25 | 4 | 2.5 |

(Evaluation of Oiliness)

As shown in table 17, it is understood that the oiliness of the edible oil and fat compositions configured from the superheated oils of samples C-12 and A-5 was reduced to a greater extent than that of the edible oil and fat composition that did not include the superheated oils.

It is also understood that the effect for reducing oiliness was slightly higher in the edible oil and fat composition configured from the superheated oil of sample C-12 than in the edible oil and fat composition configured from the superheated oil of sample A-5.

1. An oiliness-reducing agent characterized by containing, as an active ingredient, a heated oil obtained by implementing a heating treatment at 120° C. or higher on an unrefined crude oil including an expressed oil of an oil and fat raw material or an extracted oil of the oil and fat raw material, or on an oil and fat that has passed through a degumming step, a deacidification step, or a bleaching step in steps for refining the unrefined crude oil.

2. The oiliness-reducing agent according to claim 1, wherein a heated oil obtained by implementing a further refinement step, after the heating treatment at 120° C. or higher is implemented, on the unrefined crude oil or on the oil and fat that has passed through the degumming step, the deacidification step, or the bleaching step in the steps for refining the unrefined crude oil, is employed as the active ingredient.

3. The oiliness-reducing agent according to claim 1, wherein the oil and fat raw material is corn germ.

4. An edible oil and fat composition characterized by containing the oiliness-reducing agent according to claim 1.

5. A method for manufacturing an oiliness-reducing agent, the method being characterized by including a step for implementing a heating treatment at 120° C. or higher on an unrefined crude oil including an expressed oil of an oil and fat raw material or an extracted oil of the oil and fat raw material, or on an oil and fat that has passed through a degumming step, a deacidification step, or a bleaching step in steps for refining the unrefined crude oil, to obtain a heated oil.

6. The method for manufacturing an oiliness-reducing agent according to claim 5, wherein the heating treatment is carried out under conditions derived according to the following expression.
35≤(T−100)×t^{0.2}≤270
In the expression, T is the heating temperature, and t is a heating time (in minutes).

7. The method for manufacturing an oiliness-reducing agent according to claim 5, characterized in that the heating treatment is carried out on the unrefined crude oil, or on the oil and fat that has passed through the degumming step, the deacidification step, or the bleaching step in the steps for refining the unrefined crude oil, until a temperature of 140° C. or higher is reached.

8. The method for manufacturing an oiliness-reducing agent according to claim 5, including a refining step for refining the heated oil.

9. The method for manufacturing an oiliness-reducing agent according to claim 5, wherein corn germ is used as the oil and fat raw material.

10. A method for reducing the oiliness of a food product, the method being characterized in that the oiliness-reducing agent according to claim 1 is used when manufacturing a food product.

11. A method for reducing the oiliness of a food product, the method being characterized in that the edible oil and fat composition according to claim 4 is used when manufacturing a food product.
